(19) United States
(12) Patent Application Publication
(10) Pub. No.: US 2026/0134024 A1
(43) Pub. Date: May 14, 2026

(54) CLASSIFICATION OF DOCUMENTS

(71) Applicant: Box, Inc., Redwood City, CA (US)

(72) Inventors: Yi Zhao, Redwood City, CA (US); Sesh Jalagam, Union City, CA (US); Aiko Krishna, San Francisco, CA (US); David Louie, San Ramon, CA (US)

(73) Assignee: Box, Inc., Redwood City, CA (US)

(21) Appl. No.: 19/260,155

(22) Filed: Jul. 3, 2025

Related U.S. Application Data
(60) Provisional application No. 63/719,000, filed on Nov. 11, 2024.

(51) Int. Cl. G06F 16/35; G06F 40/106

(52) U.S. Cl. CPC G06F 16/35; G06F 40/106

(57) ABSTRACT

Methods, systems, and computer program products for implementing LLM-based document sensitivity classification with user-defined policies. This leverages the advanced capabilities of Large Language Models (LLMs) for nuanced document classification, transcending the limitations of rigid rules-based systems.

### RELATED APPLICATION DATA

The present application claims the benefit of priority to U.S. Provisional Patent Application Ser. No. 63/719,000 titled “METHOD AND SYSTEM TO IMPLEMENT IMPROVED SECURITY WITHIN A CONTENT MANAGEMENT SYSTEM”, filed on Nov. 11, 2024, which is hereby incorporated by reference in its entirety

### BACKGROUND

Identifying sensitive documents is important for businesses, governments, and individuals. Such documents often contain confidential or secret information, personally identifiable information (PII), or other data subject to legislation and governmental regulations. Organizations face significant obligations regarding the proper handling and protection of this information, making accurate identification a foundational requirement.

Historically, computer-implemented techniques have been used to identify such sensitive information. A common approach involves creating a rules-based system where a computing system analyzes documents against a predefined set of rules. For instance, many systems utilize regular expression (regex)-based rules to identify patterns indicative of sensitive content and classify documents accordingly.

Despite their widespread use, rules-based classification methods face significant challenges to be able to accomplish these tasks. One possible issue is to be able to strike the correct balance between being overly conservative or overly permissive. Overly conservative rules frequently lead to excessive false positives, which may incorrectly flag non-sensitive documents as being confidential. This can create unnecessary burdens, requiring manual review and potentially hindering legitimate information flow. Conversely, overly permissive rules may cause too many false negatives, failing to identify documents that genuinely contain confidential or sensitive information. Such oversights can lead to severe data breaches, regulatory non-compliance, and significant financial or reputational damage.

Therefore, there is a need for improved techniques that can efficiently and accurately classify documents containing sensitive content.

### SUMMARY

Some embodiments of the present invention provide an approach to implement LLM-based document sensitivity classification with user-defined policies. Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1 illustrates a computing environment 100 designed for implementing embodiments of the present disclosure.

FIG. 2 provides a high-level flowchart illustrating the document classification process according to some embodiments of the invention.

FIG. 3 presents an illustrative example of the kind of information that may be provided by a user.

FIG. 4 illustrates a flowchart depicting an approach for entering and managing a user's customized classification policies within the system.

FIG. 5 illustrates a flowchart detailing an approach to implement the LLM-based document classification process according to some embodiments of the invention.

FIG. 6 provides a concrete example of such a suitable prompt that may be configured for a customer.

FIG. 7 illustrates an exemplary user interface.

FIG. 8 presents another illustrative user interface.

FIG. 9 illustrates a flowchart depicting an efficient pre-filtering approach.

FIG. 10 illustrates a flowchart depicting an approach to correct for “overly-opinionated” or erroneous classifications generated by Large Language Models (LLMs).

FIG. 11 illustrates a flowchart depicting an approach to leverage historical interaction records from a Content Management System (CMS).

FIG. 12 shows an alternative approach to processing document classifications, representing another embodiment of the invention.

FIG. 13 shows an illustrative meta-prompt.

FIG. 14A and FIG. 14B present block diagrams of computer system architectures having components suitable for implementing embodiments of the present disclosure and/or for use in the herein-described environments.

### DETAILED DESCRIPTION

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

Embodiments of the present invention provide an approach to LLM-based document sensitivity classification with user-defined policies. This leverages the advanced capabilities of Large Language Models (LLMs) for nuanced document classification, transcending the limitations of rigid rules-based systems. By empowering individual users with customized classification policies and incorporating a mechanism for continuous improvement through feedback, the disclosed system offers a more adaptable and accurate solution.

The architecture of the system includes a User Policy Management Interface, enabling individuals to define and manage their specific classification policies. A Policy-to-Prompt Converter module translates these natural language policies into effective prompts for an LLM. LLM Integration ensures that a core LLM (e.g., GPT-4, Claude, LLaMA, or similar models) is responsible for the primary classification task. An integral Override Mechanism provides a system for user intervention, allowing for the correction or refinement of LLM classifications. Furthermore, the inventive approach seamlessly integrates with existing Content Management Systems (CMS), connecting the classification capabilities directly with the organization's document infrastructure.

This approach offers numerous benefits and advantages. First, it provides granular control over classifications, allowing the system to tailor sensitivity determinations to specific departmental needs, roles, or individual risk tolerances. Second, improved accuracy is achieved as user-supplied policies are more likely to align precisely with the user's actual understanding of document sensitivity. Finally, this level of customization fosters significant user buy-in, leading to greater empowerment and trust in the system's classification results.

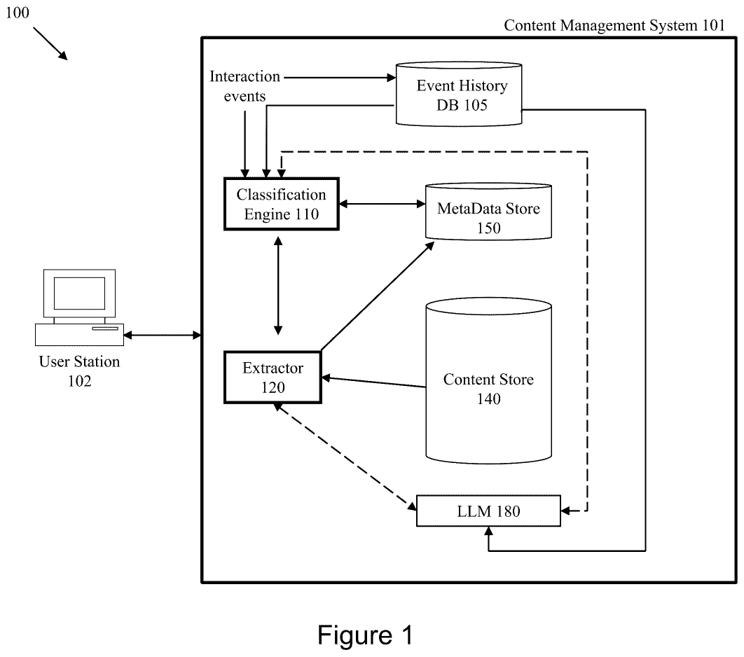

FIG. 1 illustrates a computing environment 100 designed for implementing embodiments of the present disclosure. This figure provides an overview of the system architecture, specifically detailing how documents managed by a Content Management System (CMS) 101 are processed for sensitivity classification utilizing the novel aspects of the invention.

Within the computing environment 100, the Content Management System (CMS) 101 serves as the central hub. It facilitates and manages interactions with a vast array of content objects that reside within a content store 140. These content objects can be created, modified, or accessed by multiple users operating from one or more user stations 102. Beyond human users, the CMS 101 also supports interactions initiated by non-human entities, such as AI agents, various applications (e.g., web applications, mobile applications, cloud applications) or automated workflows orchestrated by workflow management systems.

Any interaction with content objects managed by the CMS 101 generates corresponding interaction events. These events are logged and stored within an event history database 105, maintaining a detailed historical record of all activities related to the content. Examples of such interaction events include, but are not limited to, authoring a new document, editing an existing file, viewing a document, previewing content, updating information, sharing files, downloading copies, or inviting collaborators.

FIG. 1 further illustrates the integration of a classification engine 110, a component responsible for generating a sensitivity classification label for the content objects within the content store 140. In specific embodiments, the occurrence of an interaction event at the CMS 101 acts as a trigger, prompting the classification engine 110 to initiate a classification analysis of the particular content object involved in that event. This process involves an extractor 120, which is configured to retrieve the relevant data from the content object located in the content store 140, preparing it for subsequent analysis by the classification system.

In some embodiments, the classification analysis process utilizes the user/customer's own classification policies. This is a significant departure from conventional rigid, one-size-fits-all rulesets. These unique policies are specifically configured by individual users or organizations to address their distinct operational contexts and compliance requirements. For instance, a movie studio might define specialized classification tiers tailored to copyrightable intellectual property and media content types, recognizing video objects as inherently highly sensitive. Conversely, a healthcare organization would implement an entirely different set of sensitivity tiers, primarily focused on governmental regulations governing the handling of protected health information (PHI).

The core of the inventive solution, as illustrated in FIG. 1, involves leveraging an AI-based approach to overcome the inherent limitations of traditional rules-based systems, particularly their difficulty in balancing false positives and false negatives. An LLM (Large Language Model) 180 is central to this AI-driven classification. The system dynamically utilizes the user/customer's specific classification policies to construct and apply the appropriate prompt for the LLM 180, enabling it to perform a contextual classification analysis on the content object. This AI-based method customizes the analysis that adapts to the user's unique circumstances, moving beyond a restrictive set of fixed rules. Once the classification analysis is complete, the determined sensitivity label for the content object is then stored as metadata within a metadata store 150, ensuring the classification is persistently associated with the content.

The interaction between the classification engine 110 and the LLM 180 is mediated by the dynamic generation of prompts. This means that instead of relying on a hardcoded set of keywords or fixed patterns, the LLM receives contextual instructions derived directly from the user's granular policies. The LLM then employs its advanced natural language understanding capabilities to interpret the content object's meaning, context, and semantic relationships against the provided policy directives, even identifying implicit indicators of sensitivity that might elude traditional regex or keyword matching. This intelligent interpretation allows the system to identify sensitive information with greater accuracy and fewer false positives or negatives, adapting to the subtle nuances of human language and organizational data.

Furthermore, an aspect of the invention's continuous improvement mechanism is the relationship between the classification engine 110, the event history database 105, and the metadata store 150. While the LLM 180 provides an initial classification, the system incorporates an override mechanism. If a user or administrator determines that the LLM's classification is incorrect or requires adjustment, they can manually override the assigned label. This override action, along with the original LLM prediction and potentially the reason for the override, is logged in the event history database 105. This human feedback, stored alongside the document's metadata in the metadata store 150, forms a dataset that can be periodically used to fine-tune the LLM 180 or refine the prompt generation logic, continuously enhancing the system's classification accuracy and robustness over time.

Collectively, the architecture depicted in FIG. 1 represents a significant advancement over prior art. By moving beyond static rules and embracing the adaptive approach of LLMs, coupled with individualized policy customization and a robust feedback loop, the system can dynamically adjust to evolving definitions of sensitivity, organizational changes, and new types of data. This results in a highly flexible, accurate, and self-improving document classification solution that minimizes manual overhead while maximizing compliance and data security across diverse computing environments.

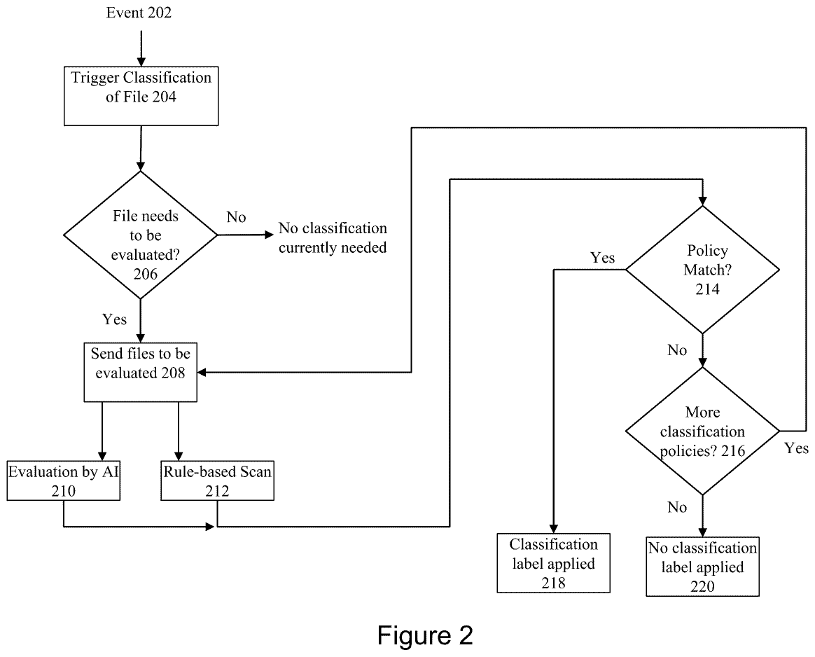

FIG. 2 provides a high-level flowchart illustrating the document classification process according to some embodiments of the invention. The process begins with the identification of an event 202, which at 204, triggers the classification of a content object, such as a file or document. This triggering event can be diverse, originating from various interactions within the Content Management System (CMS) as described in FIG. 1, for instance, a document being uploaded, edited, or accessed.

Following the trigger, a determination is made at 206 whether the content object needs to be evaluated. This step optimizes resource utilization by preventing redundant analyses. For example, if the same file was recently classified and neither its content nor the user's relevant classification policies have changed, re-evaluation may be deemed unnecessary. However, if the file is new, has undergone modifications, or if the applicable classification policies have been updated since its last assessment, then further classification analysis is initiated.

If the file requires evaluation, then it is then routed to one or more classification engines at 208. According to some embodiments of the invention, the system is designed to apply multiple types of evaluations to perform comprehensive classification. In some embodiments, AI-based evaluation performed at 210. Here, the user's specific classification policies are translated into the appropriate prompt. This prompt is then submitted to a Large Language Model (LLM) for evaluation, enabling the LLM to understand the requirements of the user's policy and apply them to the content object. The detailed mechanisms of this AI-based approach are elaborated upon in subsequent sections of this disclosure.

In addition to the AI-based approach, other types of evaluation may be performed, either in conjunction with or as a supplementary measure. For instance, at 212, a rules-based approach may be implemented, often employing regular expression (RegEx) detection. A regular expression is a sequence of characters that defines a search pattern, capable of including both literals (characters to be matched exactly) and wildcards, allowing for the detection of complex patterns within the content. This hybrid approach leverages the strengths of both symbolic (rules-based) and statistical (AI-based) methods. It is important to note that various computer-implemented detectors can be combined to achieve a particular level of confidence in a classification, often forming a chain of detectors. For example, a regex detector might provide an initial, rapid detection of specific strings of interest with high confidence, while more computationally intensive downstream detectors (e.g., ML-based detectors) can be invoked for greater accuracy only when needed, as detailed in co-pending U.S. patent application Ser. No. 17/463,372, which is incorporated by reference herein in its entirety.

Upon completion of the evaluation(s), a determination is made at 214 whether a policy match has occurred. This step verifies if the file's content satisfies the criteria established by the user's classification policies to be designated at a particular sensitivity or classification level. If a match is positively identified, then at 218, the appropriate classification label is applied to the file, embedding its determined sensitivity within its metadata.

Should no policy match be found at 214, the process proceeds to 216, where a determination is made as to whether any further classification policies or evaluation methods remain to be checked. If additional policies or evaluation strategies are available and applicable, the process loops back to 208 to continue the analysis with these additional rules or methods. However, if all applicable policies have been exhausted without a conclusive match, then at 220, it is determined that no specific classification label needs to be applied to the file based on the current policy set, indicating it may be categorized as general or non-sensitive, or it may await future policy updates. This iterative and comprehensive evaluation ensures that documents are classified with the highest possible accuracy and adherence to user-defined requirements.

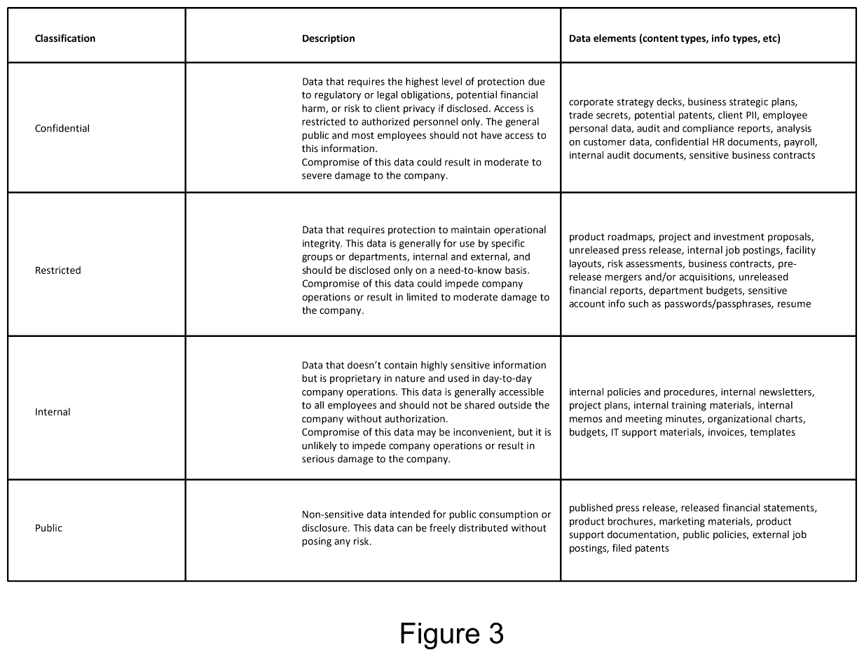

FIG. 3 presents an illustrative example of the kind of information that may be provided by a user (e.g., an enterprise customer) for their customized classification policies. Enterprise customers commonly employ a hierarchy of 2-4 classification levels for security purposes. Some approaches may include 2-3 (or more) classifications that denote varying degrees of sensitivity or require different levels of protection. Such policies generally encompass two key elements: (a) a description of the classification level and, in some cases, the associated protection measures for documents falling under that classification; and (b) examples of specific data elements relevant to that classification, such as document types (e.g., contracts, resumes) or information types (e.g., Social Security Numbers (SSN), names, driver's license numbers).

This figure specifically depicts a table detailing four distinct classification categories, providing a concrete representation of how user-defined policies are structured. Each row in the table corresponds to a different classification category. The table is organized with a first column that identifies the specific category name (e.g., “Confidential”), a second column providing a comprehensive description of the category's criteria and implications, and a third column that enumerates relevant data elements associated with that category.

As an illustration, the first row of the table details the policy for the “Confidential” classification category. The “Description” column articulates that this category pertains to: “Data that requires the highest level of protection due to regulatory or legal obligations, potential financial harm, or risk to client privacy if disclosed. Access is restricted to authorized personnel only. The general public and most employees should not have access to this information. Compromise of this data could result in moderate to severe damage to the company.” The “Data Elements” column for this “Confidential” category lists concrete examples such as: “corporate strategy decks, business strategic plans, trade secrets, potential patents, client PII, employee personal data, audit and compliance reports, analysis on customer data, confidential HR documents, payroll, internal audit documents, sensitive business contracts.” The table further includes similarly structured rows providing policies for the “Restricted”, “Internal”, and “Public” categories, demonstrating the hierarchical and comprehensive nature of user-defined classification policies. This structured input directly informs the policy-to-prompt conversion process for the LLM.

The policy information exemplified in FIG. 3 is typically managed through a user interface (e.g., a User Policy Management Interface). This interface provides users with tools to define, modify, and prioritize their classification policies. While shown as a table for clarity, the actual input mechanism may include guided forms, drop-down menus, free-text fields, or combinations thereof, allowing users to express complex rules and specific examples of sensitive data pertinent to their operations. This interface permits users and subject matter experts within an organization to directly embed their domain-specific knowledge into the classification logic, ensuring that the system's behavior aligns with their risk profile and compliance mandates.

The information presented in FIG. 3 can undergo transformation into effective prompts for the LLM 180 by the policy-to-prompt converter. Each policy, including its description and enumerated data elements, is parsed and synthesized into instructions for the LLM. For instance, the detailed description of “Confidential” data, along with its specific examples, forms a rich contextual understanding for the LLM, enabling it to recognize not just keywords but also the semantic context and implications of sensitive information. This dynamic prompt generation ensures that the LLM's classification decision is grounded in the specific, user-defined criteria, allowing for highly adaptive and accurate identification of document sensitivity without requiring re-training of the underlying LLM for each policy change.

Therefore, FIG. 3 demonstrates how the invention addresses the limitations of traditional rules-based systems by enabling a granular, user-centric approach to defining document sensitivity. By providing this level of detailed policy customization, the system effectively avoids the pitfalls of overly conservative (leading to false positives) or overly permissive (leading to false negatives) classifications. It ensures that the classification engine, powered by the LLM, understands the nuances of what constitutes sensitive information for a particular user or organization, thereby enhancing both accuracy and operational efficiency. This flexible policy framework allows the system to adapt to evolving regulatory landscapes, new data types, and changing internal security requirements without manual code modifications.

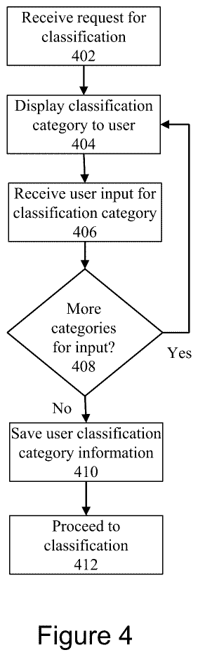

FIG. 4 illustrates a flowchart depicting an approach for entering and managing a user's customized classification policies within the system. This figure outlines the process by which an administrator or customer representative can input policy information, directly feeding into the system's ability to perform nuanced document classification.

The process begins at 402, where a request to define or modify classification policies is received. This request typically originates from an administrator or a designated representative of the customer, operating within an administrative console or a dedicated policy management interface. At 404, the interface displays a specific classification category to the user. This guides the user through the structured input process, ensuring all necessary details for each policy level are captured.

Following the display of a category, at 406, the system receives input from the user for that particular classification category. This input often involves copying and pasting information directly from the customer's existing data classification documentation, such as detailed descriptions, examples of sensitive data elements, or specific protection requirements, similar to the illustrative content shown in FIG. 3. This method minimizes manual data entry and ensures consistency with established organizational guidelines.

A determination is then made at 408 as to whether there are any further classification categories for input. If additional categories or policy levels need to be defined, the process loops back to 404, prompting the user to provide information for the next policy category. This iterative process continues until all relevant classification policies have been fully captured. Once all categories have been addressed, and no further input is required, the user-provided classification policy information is securely saved at 410. Thereafter, at 412, the system is ready, and the process proceeds to the document classification stage, now armed with the newly defined or updated custom policies.

By guiding the administrator through each classification category and prompting for specific information like descriptions and data elements, the system ensures that the policies are robust enough for the subsequent LLM-based analysis. This systematic collection also helps in preventing ambiguity or incompleteness in the policy definitions, which could otherwise lead to less accurate classifications. The user interface can also incorporate validation checks to ensure that the input conforms to expected formats or identifies potential conflicts across policy tiers, further enhancing the quality of the defined rules.

Furthermore, the flexibility of allowing input via copy/paste from existing customer data classification documents at step 406 significantly reduces the onboarding burden for organizations. Many enterprises already possess detailed internal guidelines regarding data sensitivity. This invention streamlines the process of translating those established, often complex, human-readable policies into a machine-interpretable format that the LLM can leverage. This capability directly addresses a common challenge in implementing new data classification systems, namely the significant effort required to codify existing organizational knowledge into a new technical framework.

The output of this policy entry process, saved at step 410, becomes the foundational input for the policy-to-prompt converter. This saved policy data is not merely a static record; it represents a dynamic blueprint for how the LLM will interpret and classify documents. Each time a document requires classification, the relevant policies are retrieved, and the converter uses this saved information to craft a highly specific and contextual prompt for the LLM. This ensures that the LLM's analytical power is precisely directed by the user's explicit intent.

The iterative nature of steps 404 to 408 is particularly advantageous for managing an organization's potentially diverse and evolving classification needs. It allows administrators to incrementally build out comprehensive policy sets, starting with core categories and adding more granular definitions as needed. This modular approach supports scalability and adaptability, enabling the system to grow with the organization's increasing complexity or changes in regulatory requirements. Moreover, this process can be revisited at any time to update existing policies or introduce new ones, ensuring the classification system remains current and effective.

In essence, FIG. 4 illustrates not just a data entry process, but an approach for how the system transforms human-defined policies—often qualitative and descriptive—into a structured, machine-actionable format that directly informs the advanced capabilities of the LLM. This bridge between human policy and AI execution is fundamental to achieving accurate, customizable, and continuously improving document sensitivity classification.

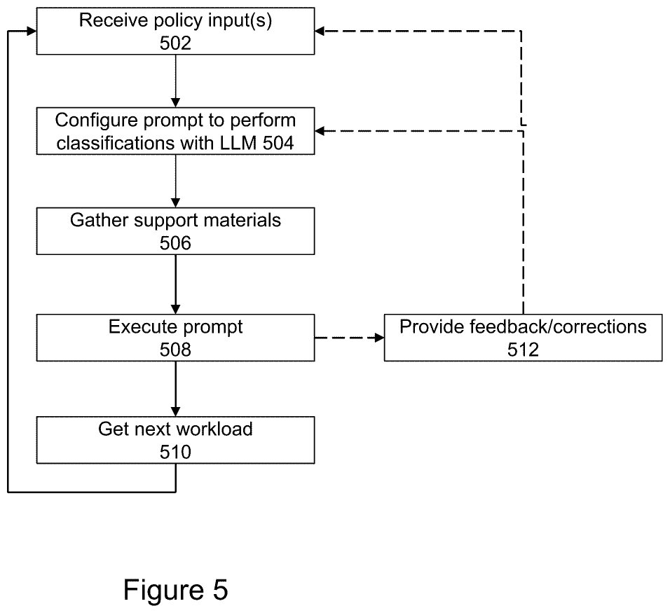

FIG. 5 illustrates a flowchart detailing an approach to implement the LLM-based document classification process according to some embodiments of the invention. This figure outlines the operational steps taken after user-defined policies have been established, focusing on how these policies are translated into actionable instructions for a Large Language Model (LLM) to perform accurate document sensitivity assessment.

The process begins at 502, where the customer's classification policy inputs are received. These inputs, representing the tailored sensitivity definitions and criteria for an organization, are typically gathered through a process like the one illustrated in FIG. 4, ensuring they are comprehensive and accurately reflect the user's requirements.

At 504, a prompt is configured to perform the classification in conjunction with an LLM. This step dynamically translates the user's specific, natural language classification policies into an effective set of instructions for the LLM. In some embodiments, this prompt functions like a sophisticated template. It includes a generic set of guiding statements that direct the LLM's behavior and task, but it also contains a customizable portion designed to insert the unique classification policies for each separate customer. This template-based approach ensures consistency in the LLM's operational framework while maintaining the flexibility to incorporate diverse, user-defined rules.

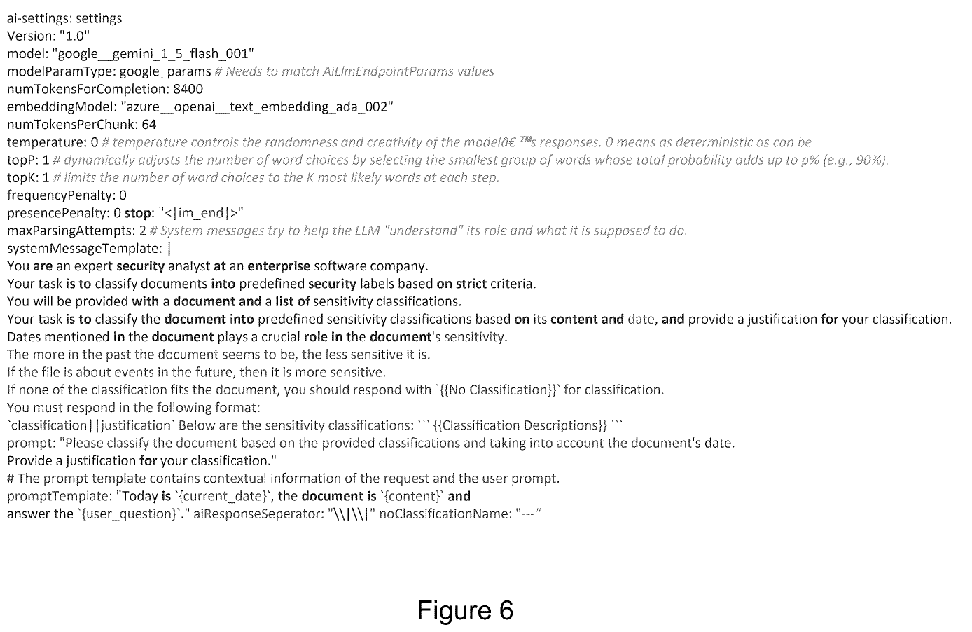

FIG. 6 provides a concrete example of such a suitable prompt that may be configured for a customer. The prompt is engineered to guide the LLM's classification process. It begins by establishing the LLM's persona and objective: “You are an expert security analyst at an enterprise software company. Your task is to classify documents into predefined security labels based on strict criteria. You will be provided with a document and a list of sensitivity classifications. Your task is to classify the document into predefined sensitivity classifications based on its content and date, and provide a justification for your classification. Dates mentioned in the document plays a crucial role in the document's sensitivity. The more in the past the document seems to be, the less sensitive it is. If the file is about events in the future, then it is more sensitive. If none of the classification fits the document, you should respond with {{No Classification}} for classification. You must respond in the following format: classification||justification Below are the sensitivity classifications: {{Classification Descriptions}} prompt: “Please classify the document based on the provided classifications and taking into account the document's date. Provide a justification for your classification.” This example demonstrates how the design of the prompt ensures that the LLM understands its role, the input format, the desired output format, and the specific classification criteria, including temporal considerations.

Returning to FIG. 5, once the prompt is configured, at 506, the necessary support materials to execute the prompt are gathered together. This typically includes the specific classification policies unique to the customer (as processed at 502) and, as well as the actual document content that needs to be classified. These materials are then assembled into the final input payload for the LLM. Next, at 508, the configured prompt is executed at the LLM. The LLM processes the document content against the instructions and policies embedded within the prompt, generating a classification output along with a justification.

At 512, feedback may be provided, which is a vital aspect of the invention's continuous improvement capabilities. This often involves performing one or more test cycles to verify the accuracy and usability of the LLM's classification results. During this feedback stage, human review or automated validation processes may identify instances where the LLM's classification is incorrect or suboptimal. Such feedback may indicate a need for refinement. Consequently, it is possible that the prompt itself may need to be modified to achieve desired classification outcomes, perhaps by refining its instructions or incorporating additional contextual guidance. Furthermore, the feedback might reveal that some of the initial inputs, such as the user's specific classification policies, need to be clarified, expanded, or adjusted to better capture the nuances of sensitive data.

The dynamic prompt configuration shown at step 504 represents a key departure from traditional machine learning approaches for classification. Instead of requiring extensive re-training or fine-tuning of a large model every time a customer's policy changes, this invention leverages the LLM's inherent ability to understand and follow natural language instructions. The policy-to-prompt converter effectively translates the user's declarative policies into imperative instructions for the LLM, making the system highly adaptable and scalable. This eliminates the significant computational overhead and time delays associated with model retraining, allowing for rapid deployment of new or updated classification rules across diverse organizational needs.

Moreover, the detailed structure of the prompt exemplified in FIG. 6 highlights the system's ability to imbue the LLM with expert persona and specific behavioral constraints. By instructing the LLM to act as an “expert security analyst” with a “strict criteria” mandate, the prompt guides the model's reasoning process, encouraging it to adopt a professional and rigorous stance during classification. This meta-instruction helps to enhance the reliability and consistency of the LLM's output, pushing it towards decisions aligned with security best practices rather than generic language understanding. The explicit requirement for a “justification” also adds a layer of transparency, enabling auditors or users to understand the rationale behind each classification, which is often a requirement in compliance-driven environments.

The inclusion of temporal considerations within the prompt (e.g., “The more in the past the document seems to be, the less sensitive it is. If the file is about events in the future, then it is more sensitive”) is another aspect demonstrated by FIG. 6. This allows the system to factor in the decaying sensitivity of information over time or the heightened sensitivity of future-oriented plans, which is a common real-world requirement for managing confidential data. Traditional rule-based systems would struggle to implement such nuanced temporal logic without complex and brittle regex patterns or external date comparisons, whereas the LLM can interpret and apply these temporal rules contextually based on the dates mentioned within the document content itself.

The iterative feedback loop at step 512 is important for the long-term efficacy and self-improvement of the classification system. When discrepancies are identified, whether due to an LLM hallucination, misinterpretation, or an evolving definition of “sensitive” from the user, this feedback is captured. This captured feedback can then be used in various ways: it can inform further refinements of the prompt generation logic (e.g., how policy inputs are converted into LLM instructions), directly fine-tune the LLM itself with corrected examples (Reinforcement Learning from Human Feedback, or RLHF), or prompt the user to re-evaluate and clarify their original classification policies. This continuous learning mechanism ensures the system remains robust and accurate in a dynamic data landscape.

Furthermore, the “No Classification” directive (e.g., {{No Classification}}) within the prompt addresses the issue of uncertainty handling. Instead of forcing a potentially inaccurate classification when a document truly does not fit any predefined category, the LLM is explicitly instructed to indicate uncertainty. This prevents false positives that could arise from an LLM “guessing” a category and allows for manual review of ambiguous documents, thereby enhancing overall system reliability and reducing false positives that lead to user fatigue.

Finally, at 510, a determination is made whether there are additional items that need to undergo processing. If more documents or content objects are awaiting classification, the process proceeds to the next workload, ensuring continuous and efficient operation of the classification system across a large corpus of documents. This iterative and self-correcting workflow ensures that the LLM-based classification system not only applies user-defined policies but also continuously learns and adapts to improve its accuracy and effectiveness over time, making it a powerful tool for modern data governance.

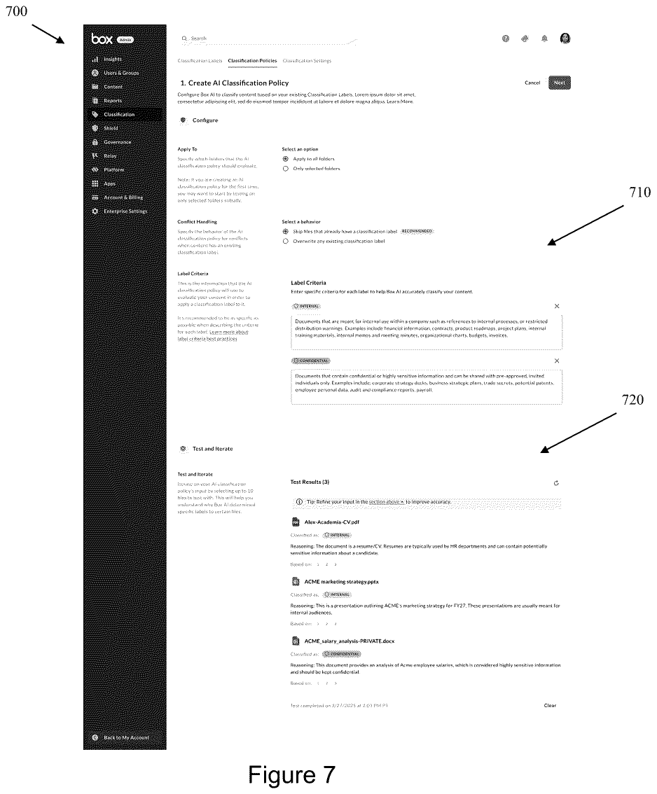

FIG. 7 illustrates an example user interface 700 designed to implement key aspects of the invention, providing a visual representation of how users interact with the system to define policies and review classification results. The interface is conceptually divided into two primary sections, facilitating both input and output functionalities. The top portion 710 of the interface is dedicated to inputting classification policy information. In this example, it shows that the user has successfully entered detailed criteria for both “Confidential” and “Internal” policies, likely mirroring the structured data input discussed in relation to FIG. 3 and the process in FIG. 4. This section allows users to define or refine their custom sensitivity tiers, including descriptive text, relevant data elements, and any associated protection guidelines. The bottom portion 720 of the interface then immediately displays the results of applying these user-defined policies to the user's documents, providing a quick feedback loop on the efficacy of the established rules. This dual view allows administrators or policy owners to directly observe the impact of their policy configurations on actual document classifications.

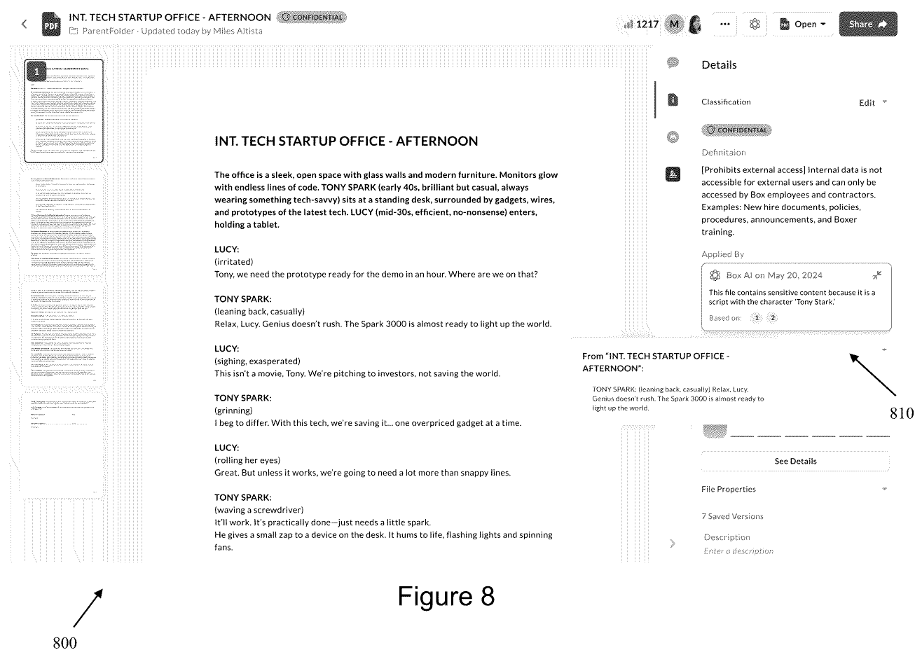

FIG. 8 presents another illustrative user interface 800, specifically showcasing the results of a document classification. In this specific example, the interface prominently displays that the content has been identified and labeled as “Confidential.” Beyond merely providing the classification label, a feature highlighted in the “Applied by” interface portion 810 is the explanation or justification for why the content was classified as such. This explanation details the LLM's reasoning, often citing specific elements within the document that triggered the “Confidential” classification based on the user's defined policies (e.g., mention of “corporate strategy decks” or “client PII”). This transparency is useful for auditing, compliance, and user understanding, allowing human reviewers to quickly validate the LLM's decision and providing the necessary context for any potential overrides or policy refinements. Together, FIGS. 7 and 8 demonstrate the intuitive, user-centric design of the system, bridging the gap between complex AI operations and practical enterprise document management.

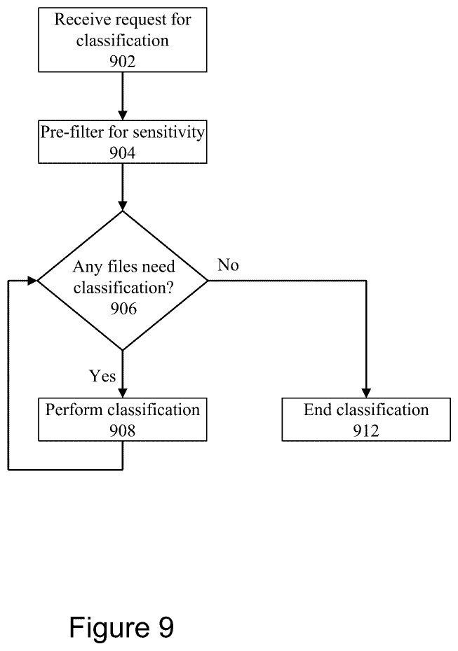

FIG. 9 illustrates a flowchart depicting an efficient pre-filtering approach designed to optimize the document classification process according to some embodiments of the invention. This pre-filtering step significantly enhances system performance by quickly identifying and excluding documents highly unlikely to contain sensitive information, thereby conserving valuable computational resources and accelerating the overall classification workflow.

The process commences at 902, where a request is received to perform classification activities. This request can arise from various triggers, such as the ingestion of new documents into the Content Management System (CMS), periodic scans of existing document repositories, or user-initiated classification demands.

Upon receiving the request, the system proceeds to 904 to perform pre-filtering for sensitivity. The core principle behind this step is to conduct a preliminary, highly efficient assessment to determine if a document is even likely to contain sensitive content before engaging more resource-intensive classification methods. This pre-filtering is typically based on easily accessible, low-cost metadata and attributes of the document. For example, documents can be pre-filtered based on file extensions (e.g., .txt, .docx, .pdf versus .jpg, .mp3), file names (e.g., “Public_Report. pdf”versus “Confidential_Strategy.xlsx”), folder locations (e.g., “Public Share” folder versus “Legal Dept-Restricted” folder), or even basic file size. This allows for a very efficient approach to quickly filter out files that are highly improbable to possess sensitive content, preventing the unnecessary expense and time associated with performing full-scale classification activities on such documents.

Following the pre-filtering, a determination is made at 906: whether, after this initial screening, any files remain that still need to undergo classification. If the pre-filtering successfully flags all documents as non-sensitive or explicitly public (meaning they require no further complex classification), then the classification activity for that batch or request ends at 912, without expending resources on advanced analysis.

On the other hand, if there are files that based on the pre-filtering still present a possibility of containing sensitive information and thus require deeper analysis, then at 908, full classification is performed on those remaining files. This means that only the documents with a genuine likelihood of being sensitive proceed to the more computationally intensive LLM-based classification process (as described in FIG. 5), ensuring that resources are intelligently allocated. This two-tiered approach significantly improves the efficiency and scalability of the overall document sensitivity classification system, allowing for the rapid processing of large volumes of data while focusing advanced analytical capabilities on the documents that truly warrant it.

The strategic integration of this pre-filtering stage at step 904 serves to improve the economic and operational efficiency of the entire classification system. Given the computational demands of Large Language Models (LLMs), indiscriminately feeding every document through the full classification pipeline would incur significant costs and processing delays, particularly for organizations managing petabytes of data. By leveraging readily available metadata, the system can swiftly discard a large percentage of documents that are clearly non-sensitive, dedicating the sophisticated analytical power of the LLM only to those files that warrant a deeper, contextual examination. This intelligent gating mechanism ensures that the system is not only accurate but also cost-effective and highly scalable. This approach therefore is useful for improving the function of the underlying computer system(s), since it reduces the amount of data that potentially needs to undergo complex processing by a processing unit (e.g., CPU, GPU or other processor), as well as reducing the quantity of data that needs to be held in in a device (such as memory), which all serve to improve the efficient functioning of the system and obtain more accurate and faster results.

Furthermore, this pre-filtering layer can incorporate user-defined exceptions or “allow lists” and “block lists” for certain metadata attributes. For example, a user might explicitly define that all documents within a folder named “Marketing-Public Releases” are to be considered non-sensitive and automatically pass the pre-filter, bypassing further scrutiny. Conversely, any document residing in a “Legal Hold” folder might automatically be flagged for immediate, high-priority classification. This allows organizations to embed their existing hierarchical data management strategies directly into the automated classification workflow, improving both speed and compliance.

In essence, FIG. 9 details an optimization layer that complements the LLM-based classification. It represents a pragmatic solution to the challenge of classifying vast document corpuses, demonstrating how smart preliminary checks can drastically reduce the workload for advanced AI models. This multi-stage classification strategy ensures that computational resources are applied judiciously, achieving high accuracy for sensitive documents while maintaining efficiency and throughput for the entire document collection.

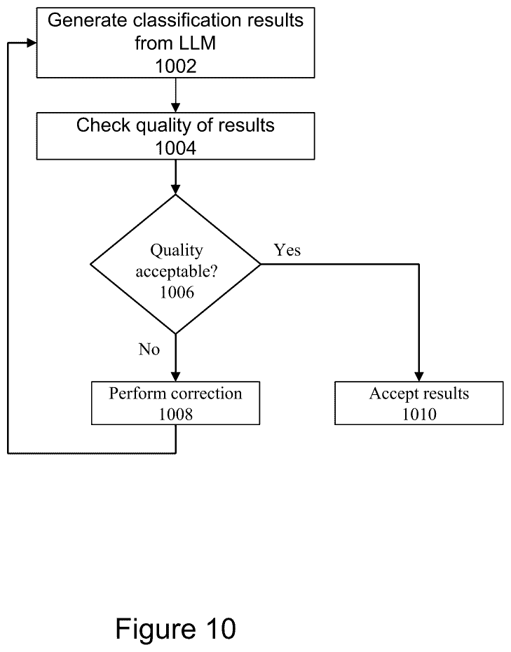

FIG. 10 illustrates a flowchart depicting an approach to correct for “overly-opinionated” or erroneous classifications generated by Large Language Models (LLMs). This technique directly addresses a challenge in deploying LLMs for sensitive tasks like document classification: the potential for the LLM to produce seemingly confident, yet fundamentally incorrect, classifications that defy common sense. For instance, an unequivocally innocuous document, clearly devoid of sensitive content, might be classified by an LLM as highly confidential. This issue stems from the dynamic and non-deterministic nature of LLMs, where their internal modeling and knowledge algorithms are constantly evolving, leading to variability in responses over time. Consequently, an LLM, at any given moment, might confidently generate a classification that is objectively wrong. The robust feedback and correction mechanism outlined in FIG. 10 is designed precisely to mitigate these instances.

The process begins at 1002, where classification results are generated from the LLM, utilizing the techniques previously described, such as the prompt configuration and execution outlined in FIG. 5. These results include the LLM's proposed classification label and, in embodiments where available, its justification for that classification.

Following the LLM's initial output, a step is performed at 1004 to check the quality of these results. Any suitable method can be employed to assess the accuracy and validity of the LLM's classification. One approach involves using a rules-based classification system as a sanity check. This allows for a rapid, deterministic verification against a set of well-established rules, quickly flagging obvious discrepancies between the LLM's output and foundational, non-negotiable criteria. Another approach involves calculating a statistical metric, such as an F-score, by comparing a subset of LLM classifications against known ground truth data, providing a quantitative measure of performance. A third method, particularly for high-stakes classifications, is human review, where an expert manually scrutinizes the LLM's output to identify misclassifications or hallucinations. This multi-faceted quality check ensures comprehensive validation.

At 1006, a determination is made as to whether the quality of the results is acceptable. This decision is based on the outcomes of the quality checks performed at step 1004, potentially against predefined thresholds for accuracy or confidence. If the quality is deemed acceptable, meaning the LLM's classification aligns with expectations and passes all validation criteria, then the results are accepted at 1010, and the document is classified accordingly within the CMS.

However, if the quality of the results is not acceptable, indicating a potential misclassification or error by the LLM, then at 1008, a correction needs to be applied. The system offers various suitable approaches to implement this correction. For instance, the prompt itself may be dynamically modified or refined to address the specific misinterpretation. This might involve reordering the categories presented to the LLM, or even augmenting the prompt with more explicit negative constraints or additional examples to steer the LLM away from the problematic classification. For example, if the LLM consistently misclassifies a certain type of innocuous document as sensitive, the prompt for that sensitive category might be subtly adjusted to include clearer counter-examples or more stringent conditions. This adaptive feedback mechanism ensures the robustness and reliability of the LLM-based classification system, maintaining human oversight while leveraging AI for scale and efficiency.

One aspect of the correction mechanism at 1008 is the ability to prioritize categories within the prompt. If the quality check reveals that the LLM consistently misclassifies documents into a specific sensitive category, or conversely, misses a critical sensitive category, the system can dynamically adjust the prompt's structure. This might involve placing the problematic classification policy higher in the prompt's instructional hierarchy or providing more explicit weighting to certain criteria associated with that category. By refining the order and emphasis of instructions, the system guides the LLM's attention and inference process, encouraging it to apply scrutiny to areas where it previously faltered.

Furthermore, the “correction” at 1008 is not limited to just prompt modification, but can also encompass data-driven feedback mechanisms. For instance, if a human review identifies a wrongful opinion, that specific document-LLM output pair, along with the human-corrected label, can be logged. This valuable “ground truth” data can then be aggregated over time and used to periodically fine-tune the underlying LLM model (e.g., through methods like Reinforcement Learning from Human Feedback—RLHF). This long-term corrective action directly enhances the LLM's intrinsic understanding of document sensitivity within the context of user policies, leading to more accurate baseline classifications and reducing the frequency of future erroneous outputs, ultimately improving the overall system's autonomous performance.

The process depicted in FIG. 10 may be considered as a form of a human-in-the-loop (HITL) strategy for some embodiments of the invention. This systematic approach ensures that while the LLM provides scalable and nuanced classification, human expertise and oversight can be used as the ultimate arbiters of accuracy. The feedback loop not only rectifies immediate errors but also drives continuous improvement, leading to a more reliable, trustworthy, and adaptable document sensitivity classification system over its operational lifetime.

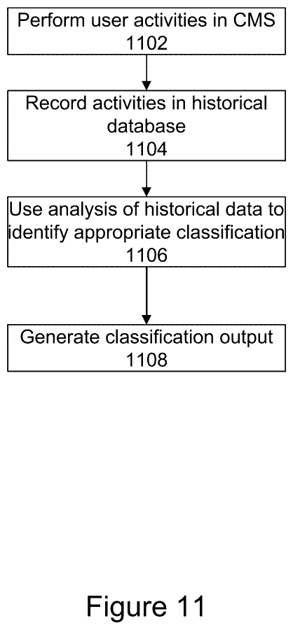

FIG. 11 illustrates a flowchart depicting an approach to leverage historical interaction records from a Content Management System (CMS) to significantly improve the document classification process. As previously noted, a fundamental characteristic of a CMS is its comprehensive logging of interactions with managed content objects. This embodiment of the invention harnesses this historical record to inform and refine the sensitivity classification, moving beyond static content analysis to incorporate behavioral context.

The process begins at 1102, where user activities are performed within the CMS. Users and other entities interact with various content objects managed by the CMS, generating a diverse array of interaction events. These events are not limited to simple access; they encompass actions such as authoring new documents, editing existing files, viewing, previewing, updating content, sharing documents with internal or external parties, downloading copies, initiating collaboration invitations, and numerous other forms of engagement. Each of these interactions provides valuable metadata about the document's lifecycle and perceived sensitivity by its users.

At 1104, a historical record of these interaction events is stored within an event history database. This database becomes a repository of behavioral intelligence, capturing not just who accessed what, but also how content was used, distributed, and collaborated upon over time. This continuous accumulation of behavioral data forms a powerful signal that traditional content-only classification methods entirely overlook.

At 1106, this historical data is analyzed to directly assist with the classification process. The system derives contextual insights from these behavioral patterns. For example, consider a scenario where a specific file is shared among a very large number of people, both within and outside the company. This widespread distribution provides a strong indication that the document is unlikely to be highly confidential or particularly sensitive, irrespective of its textual content. Even if the LLM, based on its textual analysis, might otherwise lean towards classifying the document as sensitive (perhaps due to certain keywords), the behavioral evidence of broad sharing can override or significantly reduce its perceived sensitivity. This collective “wisdom of the crowd” acts as a potent common-sense validator.

Conversely, consider another scenario where a document is strategically stored within a restricted directory hierarchy belonging to a top executive in a legal department, and its access and sharing are strictly limited to a select group of attorneys within the company. In this case, even if the LLM's initial textual analysis does not explicitly identify other strong indicators of confidentiality, the contextual clues derived from its highly restricted file location and limited sharing pattern can be profoundly instrumental. These behavioral insights provide a strong signal, augmenting the LLM's determination and guiding it to classify the document as confidential with greater certainty. Thus, the insights derived from this historical data review directly feed into and enhance the classification judgment.

Finally, at 1108, the appropriate classification output is generated with consideration of both the LLM's content-based processing and the insights derived from the interaction history data maintained by the CMS. This approach represents a significant advancement, moving beyond isolated content analysis to integrate real-world usage patterns into the sensitivity assessment. By dynamically weighting these behavioral cues, the system ensures that document classifications are not only accurate based on content but also highly contextual and aligned with organizational practices, significantly reducing misclassifications that might arise from purely semantic analysis. This integration of behavioral data with AI-driven content analysis creates a robust, adaptive, and highly intelligent document classification system.

This dynamic integration of historical interaction data at step 1106 offers a behavioral validation layer to the LLM's classification. While LLMs excel at understanding semantics and context within a document's text, they inherently lack real-world organizational context about how documents are actually used and perceived by humans over time. By incorporating metrics like sharing patterns, access frequencies, authorship trends, and even deletion history, the system gains a holistic understanding of a document's de facto sensitivity. This behavioral context can serve as a corroborating factor, confirming an LLM's high-confidence sensitive classification, or conversely, acting as a “circuit breaker” to re-evaluate an LLM's potentially overzealous sensitive classification for a document that is widely distributed or publicly accessible within the organization.

Furthermore, the analysis of historical data can help detect data drift or evolving sensitivity. For example, a document initially classified as “Internal” might, over time, exhibit sharing patterns (e.g., increased external shares, access by non-traditional departments) that indicate a gradual shift towards “Public” or a less sensitive status. Conversely, an “Internal” document might suddenly become “Confidential” due to a new legal matter, reflected by highly restricted access patterns. The continuous analysis of event history allows the system to identify these real-world changes in perceived sensitivity, prompting re-classification or raising alerts, thereby ensuring that document labels remain accurate and relevant throughout their lifecycle, rather than being static classifications.

The ability to leverage this contextual intelligence directly enhances the LLM's performance. Instead of solely relying on the LLM's intrinsic knowledge base and the user's policies, the system provides it with a richer, more specific understanding of how documents are actually treated within a given enterprise. This can inform the LLM's confidence scores, refine its internal weighting of various content indicators, or even directly modify the prompt with behavioral context (e.g., “Given this document is widely shared, consider if its content truly warrants a ‘Confidential’ label”). This intelligent augmentation allows the LLM to make more human-aligned decisions, reducing the reliance on manual overrides and improving the overall efficiency of the classification process.

In summary, FIG. 11 illustrates a mechanism that bridges the gap between static content analysis and dynamic organizational behavior. By persistently logging and intelligently analyzing CMS interaction events, the system provides a valuable feedback loop that continuously enhances the classification process. This behavioral context, combined with the LLM's semantic understanding and user-defined policies, creates a highly adaptive, accurate, and intelligent document sensitivity classification system, capable of operating effectively within the complex and evolving realities of enterprise data management.

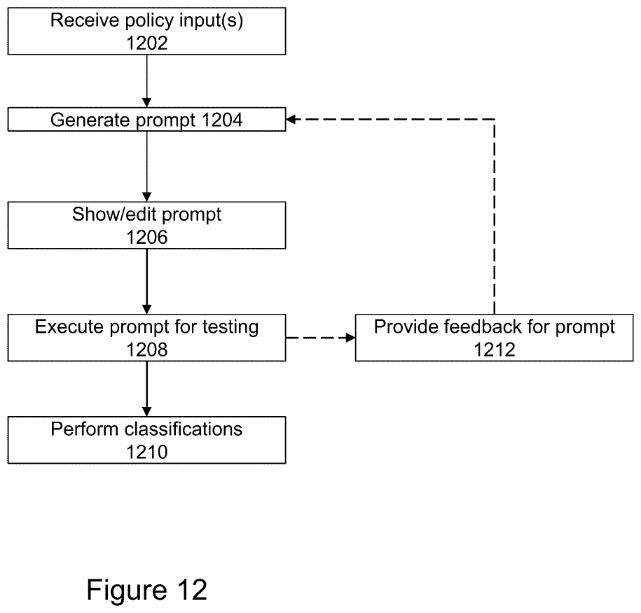

FIG. 12 shows an alternative approach to processing document classifications, representing another embodiment of the invention. In contrast to a generic prompt template that merely inserts customer-specific policy details (as seen in FIG. 5), this method focuses on generating a custom-tailored prompt for each individual customer. This allows for an additional level of prompt specificity and optimization, aligning the LLM's instructions precisely with the nuances of each organization's unique classification needs.

The process begins at 1202, where inputs are received for the customer's classification policies. These inputs are the same detailed policy definitions previously described (e.g., as exemplified in FIG. 3 and collected via FIG. 4), encompassing descriptions, data elements, and other relevant criteria for each sensitivity level.

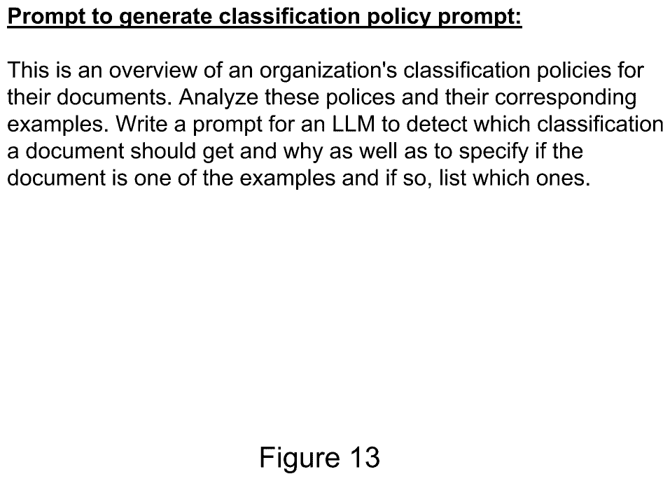

The key aspect of this approach lies at 1204, where the prompt is dynamically generated. In this embodiment, a “meta-prompt” or a first prompt is used to generate the actual classification prompt. This means an LLM is enlisted to write the prompt itself. For instance, as illustrated in FIG. 13, a meta-prompt might be: “This is an overview of an organization's classification policies for their documents. Analyze these polices and their corresponding examples. Write a prompt for an LLM to detect which classification a document should get and why as well as to specify if the document is one of the examples and if so, list which ones.” Therefore, instead of a human engineer manually creating each prompt, an LLM first processes the customer's high-level classification policies and generates an optimized prompt specifically designed to guide another LLM (or even itself in a multi-stage LLM architecture) in detecting classifications based on those policies. This leverages the LLM's understanding of effective prompting strategies and its ability to synthesize complex information into clear instructions.

This means the LLM first acts as a “prompt engineer”, analyzing the provided overview of an organization's classification policies and their examples. It then synthesizes this understanding into an optimized, context-aware prompt designed for the subsequent document classification task. This generated prompt is not just a template filler, but is instead a customized set of instructions, that is tailored to the specific logical flow, terminology, and priorities inherent in that particular customer's data classification schema. This layer of abstraction significantly enhances the system's adaptability and reduces the manual effort required to fine-tune classification behavior for diverse clientele.

Next, at 1206, the LLM-generated prompt is presented to the administrator for the customer. This step provides an opportunity for human oversight and refinement. The administrator can review the generated prompt and apply any desired edits, ensuring that the AI-generated instructions align with the organization's intent and to correct any content issues that might not have been fully captured by the initial policy overview. This human-in-the-loop validation of the prompt adds an additional layer of control and accuracy to the automated prompt generation process.

Following the potential edits, at 1208, the generated prompt is executed for testing purposes. The administrator is typically provided with an interface to upload one or more sample files, allowing them to directly test the accuracy and efficacy of the newly generated and validated prompt against real-world documents. This testing phase is iterative, allowing for an evaluation of the prompt's performance. Based on the test outcomes, at 1212, fine-tuning may occur for the prompt. This fine-tuning might involve further manual adjustments by the administrator or even an iterative re-submission to the meta-prompt LLM for further optimization. Once the customer (represented by the administrator) is satisfied with the prompt's outcome and its ability to accurately classify documents according to their policies, the administrator saves the classification policy along with this custom-generated and validated prompt. Subsequently, at 1210, ongoing classification activities for that customer's documents can commence using this highly optimized, custom-generated prompt, ensuring superior accuracy and alignment with specific organizational needs.

This advanced prompt generation mechanism may offer benefits over a fixed template approach, particularly in handling highly custom or complex organizational policies. A generic template might struggle to capture the unique legal jargon, industry-specific nuances, or layered sensitivity dependencies that some enterprises employ. By having an LLM synthesize the classification prompt, the system can dynamically incorporate these complexities into the prompt's instructions, ensuring the target LLM for classification is equipped with the most precise and effective directives possible. This may sometimes result in superior classification accuracy for highly customized scenarios.

Furthermore, allowing administrators to review and edit the generated prompt directly provides control and transparency over the “black box” nature often associated with AI. The ability to test the prompt with real files and fine-tune its behavior before deployment ensures that the final solution meets desired customer needs and rigorous enterprise standards for accuracy and compliance. This collaborative human-AI approach may be useful to accelerate the adoption and integration of the classification system into an organization's existing workflows.

The iterative fine-tuning loop at 1212 not only addresses immediate accuracy concerns but also contributes to the long-term robustness and adaptability of the system. Over time, as an organization's data classification policies evolve, or as new types of sensitive content emerge, this dynamic prompt generation and refinement process allows the system to update its classification logic. Instead of manual re-engineering for each change, the system can leverage the LLM's prompt generation capabilities to quickly adapt, ensuring that the classification rules remain current and effective without significant human intervention.

### System Architecture Overview

### Additional System Architecture Examples

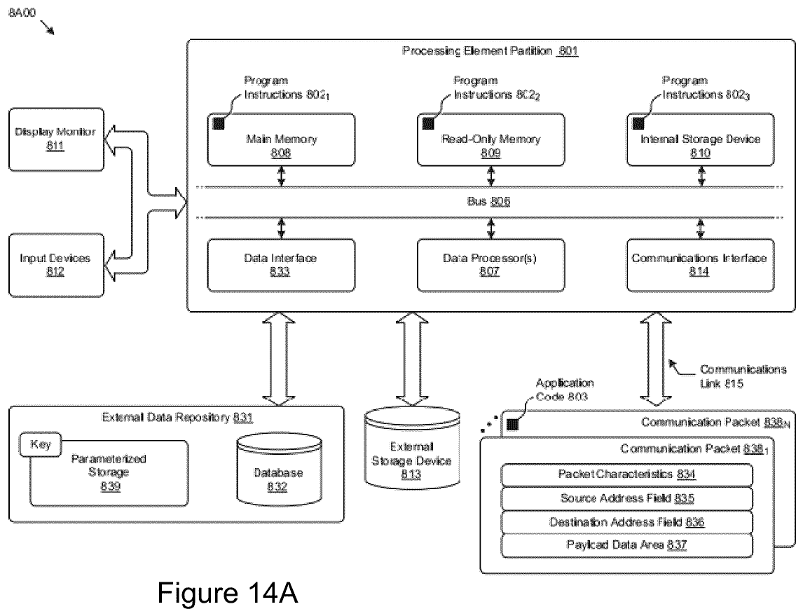

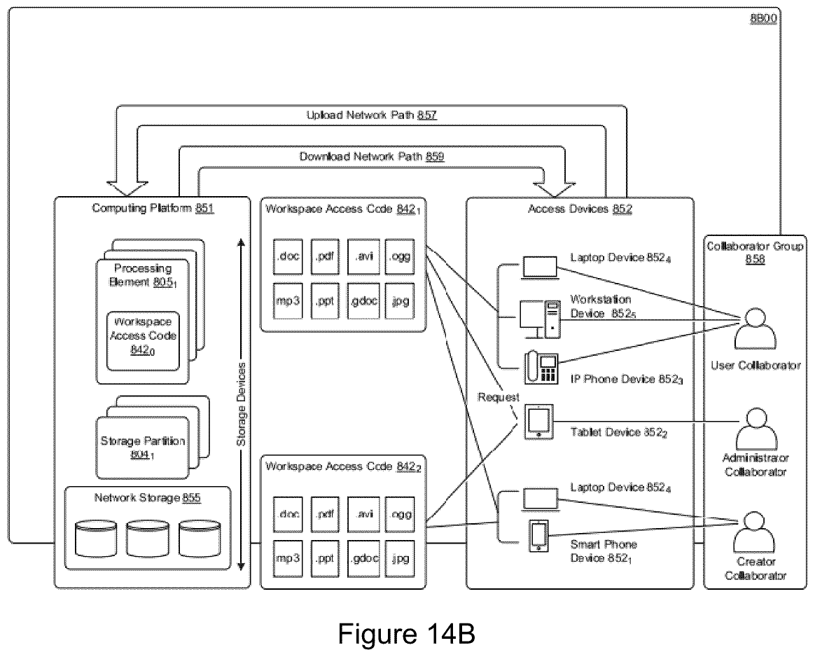

FIG. 14A depicts a block diagram of an instance of a computer system 8A00 suitable for implementing embodiments of the present disclosure. Computer system 8A00 includes a bus 806 or other communication mechanism for communicating information. The bus interconnects subsystems and devices such as a central processing unit (CPU), or a multi-core CPU (e.g., data processor 807), a system memory (e.g., main memory 808, or an area of random access memory (RAM)), a non-volatile storage device or non-volatile storage area (e.g., read-only memory 809), an internal storage device 810 or external storage device 813 (e.g., magnetic or optical), a data interface 833, a communications interface 814 (e.g., PHY, MAC, Ethernet interface, modem, etc.). The aforementioned components are shown within processing element partition 801, however other partitions are possible. Computer system 8A00 further comprises a display 811 (e.g., CRT or LCD), various input devices 812 (e.g., keyboard, cursor control), and an external data repository 831.

According to an embodiment of the disclosure, computer system 8A00 performs specific operations by data processor 807 executing one or more sequences of one or more program instructions contained in a memory. Such instructions (e.g., program instructions 802₁, program instructions 802₂, program instructions 802₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 8A00 performs specific networking operations using one or more instances of communications interface 814. Instances of communications interface 814 may comprise one or more networking ports that are configurable (e.g., pertaining to speed, protocol, physical layer characteristics, media access characteristics, etc.) and any particular instance of communications interface 814 or port thereto can be configured differently from any other particular instance. Portions of a communication protocol can be carried out in whole or in part by any instance of communications interface 814, and data (e.g., packets, data structures, bit fields, etc.) can be positioned in storage locations within communications interface 814, or within system memory, and such data can be accessed (e.g., using random access addressing, or using direct memory access DMA, etc.) by devices such as data processor 807.

Communications link 815 can be configured to transmit (e.g., send, receive, signal, etc.) any types of communications packets (e.g., communication packet 838₁, communication packet 838_{N}) comprising any organization of data items. The data items can comprise a payload data area 837, a destination address 836 (e.g., a destination IP address), a source address 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 831, which in turn can be formatted into any one or more storage areas, and which can comprise parameterized storage 839 accessible by a key (e.g., filename, table name, block address, offset address, etc.).

Execution of the sequences of instructions to practice certain embodiments of the disclosure are performed by a single instance of a computer system 8A00. According to certain embodiments of the disclosure, two or more instances of computer system 8A00 coupled by a communications link 815 (e.g., LAN, public switched telephone network, or wireless network) may perform the sequence of instructions required to practice embodiments of the disclosure using two or more instances of components of computer system 8A00.

Computer system 8A00 may transmit and receive messages such as data and/or instructions organized into a data structure (e.g., communications packets). The data structure can include program instructions (e.g., application code 803), communicated through communications link 815 and communications interface 814. Received program instructions may be executed by data processor 807 as it is received and/or stored in the shown storage device or in or upon any other non-volatile storage for later execution. Computer system 8A00 may communicate through a data interface 833 to a database 832 on an external data repository 831. Data items in a database can be accessed using a primary key (e.g., a relational database primary key).

Processing element partition 801 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 807. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to preventing leakage of secure content objects beyond a predefined secure area of a local computing environment. A module may include one or more state machines and/or combinational logic used to implement or facilitate the operational and/or performance characteristics in systems that prevent leakage of secure content objects beyond a predefined secure area of a local computing environment.

Various implementations of database 832 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of preventing leakage of secure content objects beyond a predefined secure area of a local computing environment). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations that prevent leakage of secure content objects beyond a predefined secure area of a local computing environment, and/or for improving the way data is manipulated when performing computerized operations pertaining to implementing a secure container in a local computing environment.

FIG. 14B depicts a block diagram of an instance of a cloud-based environment 8B00. Such a cloud-based environment supports access to workspaces through the execution of workspace access code (e.g., workspace access code 842₀, workspace access code 842₁, and workspace access code 842₂). Workspace access code can be executed on any of access devices 852 (e.g., laptop device 852₄, workstation device 852₅, IP phone device 852₃, tablet device 852₂, smart phone device 852₁, etc.), and can be configured to access any type of object. Strictly as examples, such objects can be folders or directories or can be files of any filetype. A group of users can form a collaborator group 858, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 851, including in a middleware setting. As shown, a portion of the workspace access code resides in and can be executed on one or more processing elements (e.g., processing element 805₁). The workspace access code can interface with storage devices such as networked storage 855. Storage of workspaces and/or any constituent files or objects, and/or any other code or scripts or data can be stored in any one or more storage partitions (e.g., storage partition 804₁). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 857). A stored workspace can be delivered to a particular user and/or shared with other particular users via a download (e.g., a download from a processing element to an access device over a download network path 859).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method, comprising:
receiving user-specific classification policies, wherein the user-specific classification policy defines a plurality of sensitivity classification categories and criteria for assigning content to the categories;
configuring a prompt for a Large Language Model (LLM), wherein the prompt includes instructions for the LLM to classify documents based on the user-specific classification policy;
receiving a document to be classified; and
executing the prompt, along with the document, at an LLM to generate an LLM-based classification for the document.

2. The method of claim 1, wherein user feedback is received for the LLM-based classification, and the user feedback comprises an override of the LLM-based classification when the LLM-based classification is determined to be incorrect.

3. The method of claim 1, wherein generating a prompt further comprises employing a separate Large Language Model (LLM) to automatically generate the prompt based on the user-specific classification policy.

4. The method of claim 1, further comprising leveraging historical interaction data associated with the electronic document to refine the LLM-based classification.

5. The method of claim 4, wherein, wherein leveraging historical interaction data comprises analyzing document sharing patterns or content locations within a content management system (CMS).

6. The method of claim 1, wherein the user-specific classification policy comprises at least one of: a natural language description for a sensitivity classification category or a specific example of data elements associated with the sensitivity classification category.

7. The method of claim 1, further comprising performing pre-filtering on the electronic document prior to executing the prompt at the LLM, wherein the pre-filtering comprises assessing metadata of the document to determine a likelihood of containing sensitive content.

8. The method of claim 1, further comprising checking a quality of the LLM-based classification; and applying a correction if the quality is determined to be unacceptable.

9. A non-transitory computer readable medium having stored thereon a sequence of instructions which, when stored in memory and executed by one or more processors causes the one or more processors to perform a set of acts, the set of acts comprising:
receiving user-specific classification policies, wherein the user-specific classification policy defines a plurality of sensitivity classification categories and criteria for assigning content to the categories;
configuring a prompt for a Large Language Model (LLM), wherein the prompt includes instructions for the LLM to classify documents based on the user-specific classification policy;
receiving a document to be classified; and
executing the prompt, along with the document, at an LLM to generate an LLM-based classification for the document.

10. The computer readable medium of claim 9, wherein user feedback is received for the LLM-based classification, and the user feedback comprises an override of the LLM-based classification when the LLM-based classification is determined to be incorrect.

11. The computer readable medium of claim 9, wherein generating a prompt further comprises employing a separate Large Language Model (LLM) to automatically generate the prompt based on the user-specific classification policy.

12. The computer readable medium of claim 9, further comprising leveraging historical interaction data associated with the electronic document to refine the LLM-based classification.

13. The computer readable medium of claim 12, wherein, wherein leveraging historical interaction data comprises analyzing document sharing patterns or content locations within a CMS.

14. The computer readable medium of claim 9, wherein the user-specific classification policy comprises at least one of: a natural language description for a sensitivity classification category or a specific example of data elements associated with the sensitivity classification category.

15. The computer readable medium of claim 9, further comprising performing pre-filtering on the electronic document prior to executing the prompt at the LLM, wherein the pre-filtering comprises assessing metadata of the document to determine a likelihood of containing sensitive content.

16. The computer readable medium of claim 9, further comprising checking a quality of the LLM-based classification; and applying a correction if the quality is determined to be unacceptable.

17. A system comprising:
a storage medium having stored thereon a sequence of instructions; and
one or more processors that execute the sequence of instructions to cause the one or more processors to perform a set of acts, the set of acts comprising: receiving user-specific classification policies, wherein the user-specific classification policy defines a plurality of sensitivity classification categories and criteria for assigning content to the categories; configuring a prompt for a Large Language Model (LLM), wherein the prompt includes instructions for the LLM to classify documents based on the user-specific classification policy; receiving a document to be classified; and executing the prompt, along with the document, at an LLM to generate an LLM-based classification for the document.

18. The system of claim 17, wherein user feedback is received for the LLM-based classification, and the user feedback comprises an override of the LLM-based classification when the LLM-based classification is determined to be incorrect.

19. The system of claim 17, wherein generating a prompt further comprises employing a separate Large Language Model (LLM) to automatically generate the prompt based on the user-specific classification policy.

20. The system of claim 17, further comprising leveraging historical interaction data associated with the electronic document to refine the LLM-based classification.

21. The system of claim 20, wherein, wherein leveraging historical interaction data comprises analyzing document sharing patterns or content locations within a CMS.

22. The system of claim 17, wherein the user-specific classification policy comprises at least one of: a natural language description for a sensitivity classification category or a specific example of data elements associated with the sensitivity classification category.

23. The system of claim 17, further comprising performing pre-filtering on the electronic document prior to executing the prompt at the LLM, wherein the pre-filtering comprises assessing metadata of the document to determine a likelihood of containing sensitive content.

24. The system of claim 17, further comprising checking a quality of the LLM-based classification; and applying a correction if the quality is determined to be unacceptable.
